(19) United States
(12) Patent Application Publication
(10) Pub. No.: US 2019/0098145 A1
(43) Pub. Date: Mar. 28, 2019

(54) DISPLAY DEVICE, IMAGE FORMING APPARATUS, AND DISPLAY METHOD

(71) Applicants: KABUSHIKI KAISHA TOSHIBA, Tokyo (JP); TOSHIBA TEC KABUSHIKI KAISHA, Tokyo (JP)

(72) Inventor: Motoki Ii, Izunokuni Shizuoka (JP)

(21) Appl. No.: 15/713,918

(22) Filed: Sep. 25, 2017

(51) Int. Cl. H04N 1/00; G01J 1/04; G03G 15/00

(52) U.S. Cl. CPC H04N 1/0049; G01J 1/0403; H04N 1/00474; H04N 1/00496; H04N 1/00411; H04N 1/00323; H04N 2201/0094; G06K 2215/0082; G03G 15/5016

(57) ABSTRACT

A display device includes a display, a first motor, an illuminance sensor, and a processor. The display displays information. The first motor changes a direction of a display surface of the display. The processor determines a first direction corresponding to a direction from a human sensor or the display surface to the eyes of the operator based on first sensing data output from the human sensor. The processor controls the first motor so that a normal direction of the display surface is the first direction when an illuminance of light incident from the first direction included in second sensing data output from the illuminance sensor is less than a first threshold. The processor controls the first motor so that the normal direction is a second direction different from the first direction when the illuminance of light incident from the first direction is the first threshold or more.

### FIELD

Embodiments described herein relate generally to a display device, an image forming apparatus, and a display method.

### BACKGROUND

An image forming apparatus such as an MFP, a copying machine, a printer, or a facsimile machine, or the like includes a display such as a liquid crystal display. In such a display, light striking on a display surface may be reflected and the display may be difficult to see.

### DESCRIPTION OF THE DRAWINGS

FIG. 1 is a perspective view illustrating an example of an appearance of an image forming apparatus according to a first embodiment and a fourth embodiment.

FIG. 2 is a block diagram illustrating a main circuit configuration and a computer connected to the image forming apparatus.

FIG. 3 is a side view explaining an outline and an operation.

FIG. 4 is a flowchart illustrating an example of a control process according to the first embodiment by a processor in FIG. 2.

FIG. 5 is a side view explaining an operation of the image forming apparatus in FIG. 1.

FIG. 6 is a graph illustrating an example of a measured value of an illuminance sensor and a measured value of a human sensor.

FIG. 7 is a side view explaining an operation of the image forming apparatus in FIG. 1.

FIG. 8 is a graph illustrating an example of a measured value of the illuminance sensor and a measured value of the human sensor.

FIG. 9 is a block diagram illustrating a main circuit configuration of an image forming apparatus and a computer connected to the image forming apparatus according to a second embodiment and a third embodiment.

FIG. 10 is a side view explaining an outline and an operation in FIG. 9.

FIG. 11 is a flowchart illustrating an example of a control process according to the second embodiment by a processor in FIG. 9.

FIG. 12 is a flowchart illustrating an example of a control process according to the third embodiment by the processor in FIG. 9.

FIG. 13 is a flowchart illustrating an example of a control process according to the fourth embodiment by the processor in FIG. 2.

### DETAILED DESCRIPTION

In general, according to one embodiment, a display device includes a display, a first motor, an illuminance sensor, and a processor. The display displays information. The first motor changes a direction of a display surface of the display. The processor determines a first direction corresponding to a direction from a human sensor or the display surface to the eyes of the operator based on first sensing data output from the human sensor. The processor controls the first motor so that a normal direction of the display surface is the first direction when an illuminance of light incident on the illuminance sensor in a direction opposite to the first direction included in second sensing data output from the illuminance sensor is less than a first threshold. The processor controls the first motor so that the normal direction is a second direction different from the first direction when the illuminance of light incident on the illuminance sensor in the direction opposite to the first direction is the first threshold or more.

Hereinafter, an image forming apparatus according to some embodiments will be described with reference to the drawings. For the sake of explanation, in each drawing used for explaining an embodiment, scales of each of units may be appropriately changed in some cases. In addition, for the sake of explanation, in each drawing used for explaining an embodiment, configurations may be omitted. First Embodiment

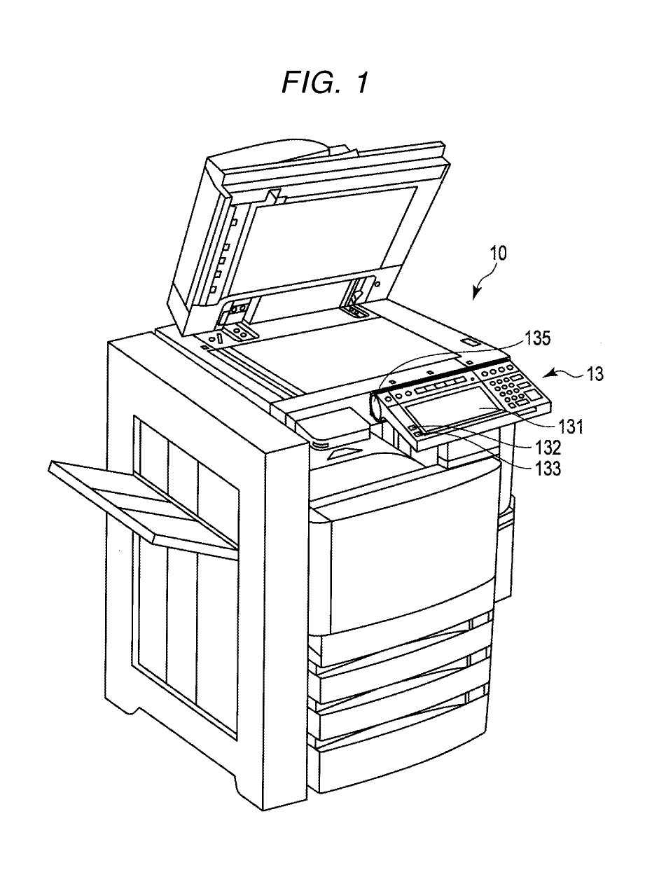

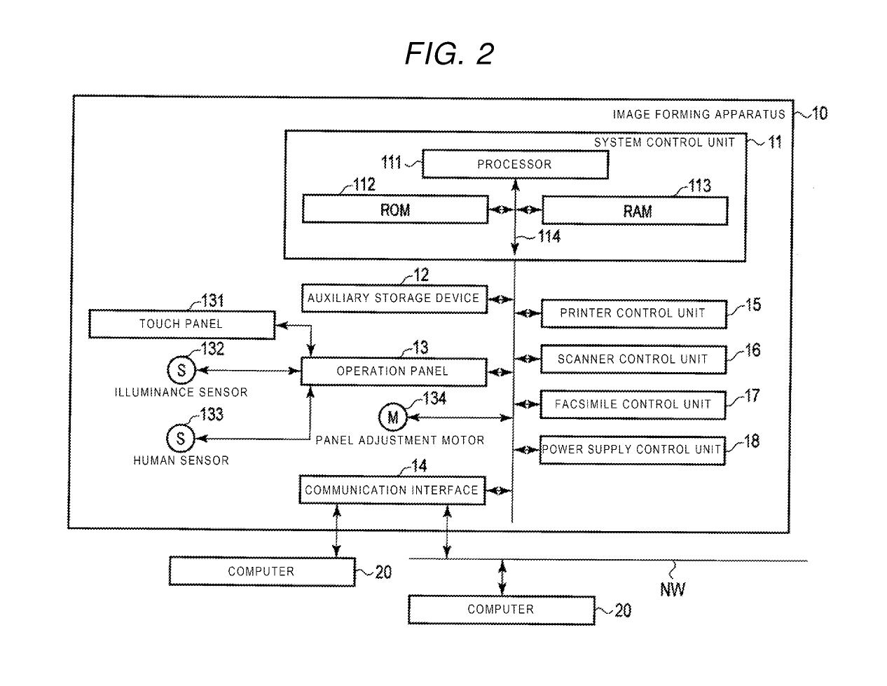

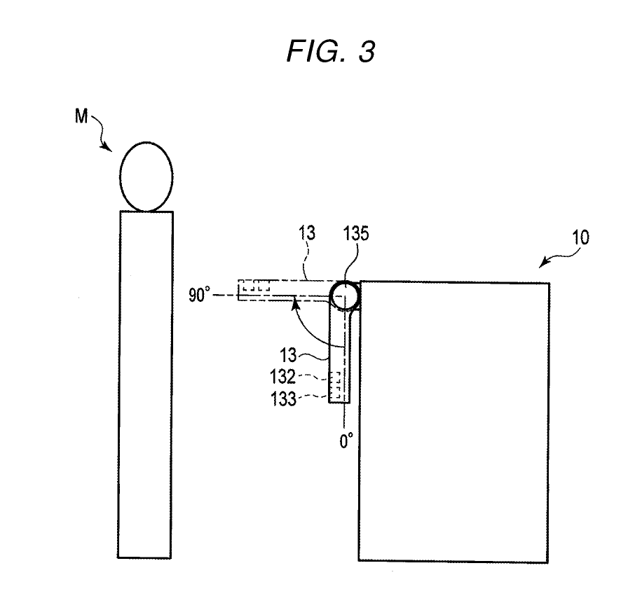

An image forming apparatus 10 according to a first embodiment will be described with reference to FIGS. 1 to 3. FIG. 1 is a perspective view illustrating an example of an appearance of the image forming apparatus 10. FIG. 2 is a block diagram illustrating a main circuit configuration of the image forming apparatus 10 and a computer connected to the image forming apparatus. FIG. 3 is a side view explaining an outline and an operation of the image forming apparatus 10.

The image forming apparatus 10 has a printing function of forming an image on a printing medium or the like using a recording material such as toner or ink. The printing medium is, for example, sheet-like paper, resin, or the like. In addition, the image forming apparatus 10 has a scanning function of reading an image from a document on which the image is formed, or the like. Furthermore, the image forming apparatus 10 has a copy function of printing an image read from the document on another printing medium. In addition, the image forming apparatus 10 has a fax function. The image forming apparatus is, for example, a multifunction peripheral (MFP), a copying machine, a printer, a facsimile, or the like. The image forming apparatus 10 includes a system control unit 11, an auxiliary storage device 12, an operation panel 13, a communication interface 14, a printer control unit 15, a scanner control unit 16, a facsimile control unit 17, and a power supply control unit 18. The image forming apparatus 10 is an example of a display device.

The system control unit 11 performs control of each unit of the image forming apparatus 10. The system control unit 11 includes a processor 111, a read-only memory (ROM) 112, and a random-access memory (RAM) 113. The system control unit 11 is an example of a control circuit.

The processor 111 corresponds to a central portion of a computer that performs processes such as calculation and control necessary for the operation of the image forming apparatus 10. The processor 111 controls each unit to realize various functions of the image forming apparatus 10 based on a program such as system software, application software, or firmware stored in the ROM 112, the auxiliary storage device 12, or the like. The processor 111 is, for example, a central processing unit (CPU), a micro processing unit (MPU), a system on a chip (SoC), a digital signal processor (DSP), a graphics processing unit (GPU), or the like. Alternatively, the processor 111 is a combination thereof. The processor 111 is an example of the control circuit. The computer in which the processor 111 is the central portion is an example of the control circuit.

The ROM 112 corresponds to a main storage device of the computer in which the processor 111 is the central portion. The ROM 112 is a nonvolatile memory used exclusively for reading data. The ROM 112 stores the above-described program. In addition, the ROM 112 stores data used for the processor 111 to perform various processes, various setting values, or the like.

The RAM 113 corresponds to the main storage device of the computer in which the processor 111 is the central portion. The RAM 113 is a memory used for reading and writing data. The RAM 113 stores data temporarily used for the processor 111 to perform various processes and is used as a so-called work area, or the like.

The auxiliary storage device 12 corresponds to an auxiliary storage device of the computer in which the processor 111 is the central portion. The auxiliary storage device 12 is, for example, an electric erasable programmable read-only memory (EEPROM), a hard disk drive (HDD), a solid state drive (SSD), or the like. The auxiliary storage device 12 may store the above-described program. In addition, the auxiliary storage device 12 stores data used for the processor 111 to perform various processes, data generated by the process in the processor 111, various setting values, or the like. Moreover, the image forming apparatus 10 may include an interface capable of inserting a storage medium such as a memory card, or a Universal Serial Bus (USB) memory instead of the auxiliary storage device 12 or in addition to the auxiliary storage device 12.

A program stored in the ROM 112 or the auxiliary storage device 12 includes a control program which is described with respect to the control process described later. As an example, the image forming apparatus 10 is transferred to the administrator of the image forming apparatus 10 or the like in a state where a control program is stored in the ROM 112 or the auxiliary storage device 12. However, the image forming apparatus 10 may be transferred to the administrator or the like in a state where a control program which is described with respect to the control process described later is not stored in the ROM 112 or the auxiliary storage device 12. In addition, the image forming apparatus 10 may be transferred to the administrator or the like in a state where another control program is stored in the ROM 112 or the auxiliary storage device 12. Thus, the control program described with respect to the control process described later may be separately transferred to the administrator or the like, and the control program may be written to the ROM 112 or the auxiliary storage device 12 under an operation by the administrator or a serviceman. In this case, the transfer of the control program can be realized, for example, by recording on a removable storage medium such as a magnetic disk, a magneto optical disk, an optical disk, or a semiconductor memory, or by downloading via a network.

The program stored in the ROM 112 or the auxiliary storage device 12 includes, for example, a threshold T1, a threshold T2, a threshold U1, a threshold U2, and a threshold D. Moreover, the threshold T1, the threshold T2, the threshold U1, the threshold U2, and the threshold D are, for example, values set by a designer of the image forming apparatus 10 or the like. Alternatively, each value of the threshold T1, the threshold T2, the threshold U1, the threshold U2, and the threshold D is a value set by an administrator of the image forming apparatus 10 or the like. The threshold T1 is an example of a first threshold. The threshold T2 is an example of a second threshold.

The operation panel 13 includes buttons which are operated by an operator M of the image forming apparatus 10, a touch panel 131, an illuminance sensor 132, a human sensor 133, a panel adjustment motor 134, a rotation unit 135, and the like. The buttons included in the operation panel 13 function as an input device that accepts an operation by the operator M.

The touch panel 131 includes a display such as a liquid crystal display or an organic EL display, and a touch pad stacked on the display. The display included in the touch panel 131 functions as a display device which displays a screen for notifying the operator M of various types of information. In addition, the touch pad included in the touch panel 131 functions as an input device which receives a touch operation by the operator M.

In addition, the touch panel 131 displays various types of information regarding the image forming apparatus 10 under a control of the processor 111. The various types of information include, for example, information regarding various functions such as printing, scanning, copying, or facsimile. The various types of information include, for example, information indicating a state of the image forming apparatus 10 or a setting value.

The illuminance sensor 132 measures illuminance based on light incident on the illuminance sensor 132 from a sensor direction. The illuminance sensor 132 outputs a measured value. Moreover, the illuminance sensor 132 is, for example, provided so that the sensor direction faces a normal direction of a display surface side of a display surface of the touch panel 131. That is, the illuminance sensor 132 measures an illuminance of light incident on the illuminance sensor 132 in a direction opposite to the normal direction of the display surface side of the display surface of the touch panel 131. A value output from the illuminance sensor is an example of second sensing data.

The human sensor 133 measures and outputs, for example, a physical quantity that is changed by a distance to an object such as the operator M in the sensor direction. A value output from the human sensor 133 has, for example, a larger value as the distance to the object is shorter. The human sensor 133 performs measurement using, for example, an infrared ray, visible light or an electromagnetic wave such as a radio wave, an ultrasonic wave, or a combination thereof. Moreover, the human sensor 133 is provided so that, for example, the sensor direction faces the normal direction on the display surface side of the display surface of the touch panel 131. A value output from the human sensor 133 is an example of first sensing data.

Moreover, the arrangement of the illuminance sensor 132 and the human sensor 133 illustrated in FIGS. 1 and 3 is an example. Therefore, the illuminance sensor 132 and the human sensor 133 may be provided at positions different from those illustrated in FIGS. 1 and 3.

The panel adjustment motor 134 is a motor that rotates the operation panel 13 in an elevation and depression angle direction. The panel adjustment motor 134 is an example of a first motor.

The rotation unit 135 is, for example, a hinge. The operation panel 13 rotates integrally with the touch panel 131, the illuminance sensor 132, and the human sensor 133. As illustrated in FIG. 3, the operation panel 13 is rotatable around the rotation unit 135 in the elevation and depression angle direction, for example, in a range including 0° to 90°. Moreover, when the display surface of the touch panel 131 is perpendicular to a ground and the display surface faces a standing side of the operator M, an angle of the touch panel 131 is 0°. That is, a direction facing a front of the image forming apparatus 10 is 0°. When the display surface of the touch panel 131 is parallel to the ground and the display surface faces a side opposite to the ground, the angle of the touch panel 131 is 90°. That is, a direction in which a ceiling or a top exists is 90°. Moreover, a rotatable range of the rotation unit 135 may be wider or narrower than 0° to 90°.

The communication interface 14 is an interface through which the image forming apparatus 10 communicates with a computer 20 or the like. The communication interface 14 is, for example, an interface conforming to a standard such as USB or Ethernet (registered trademark). The computer 20 is, for example, connected to the communication interface 14 via a network NW. Alternatively, the computer 20 is directly connected to the communication interface 14 without the network NW. The image forming apparatus 10, the system control unit 11, and the operation panel 13 are connected to the network NW. The network NW is typically a communication network including a local area network (LAN). The network NW may be a communication network including a wide area network (WAN). The computer 20 is, for example, a personal computer (PC), a server, a smart phone, a tablet PC, or the like. The computer 20 has a function of transmitting a printing job to the image forming apparatus 10.

The printer control unit 15 controls a printer included in the image forming apparatus 10. The printer is a laser printer, an inkjet printer, or another type printer.

The scanner control unit 16 controls a scanner type included in the image forming apparatus 10. The scanner is, for example, an optical reduction type including an imaging device such as a charge-coupled device (CCD) image sensor. Alternatively, the scanner is a contact image sensor (CIS) system including an imaging device such as a complementary metal-oxide-semiconductor (CMOS) image sensor. Alternatively, the scanner is another known system.

The facsimile control unit 17 performs control regarding a fax function.

The power supply control unit 18 controls power supply included in the image forming apparatus 10. The power supply supplies power to each unit of the image forming apparatus 10.

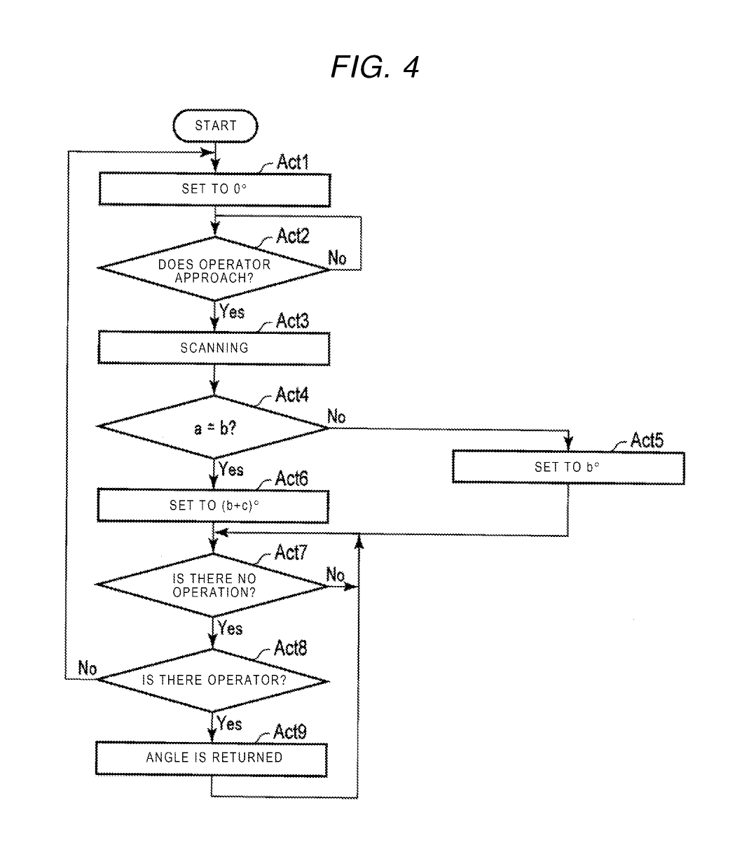

Hereinafter, an operation of the image forming apparatus 10 according to the first embodiment will be described with reference to FIGS. 4 to 8. A content of a process in the following operation description is an example and various processes capable of obtaining similar results can be appropriately used. FIG. 4 is a flowchart illustrating a control process by the processor 111 of the image forming apparatus 10. The processor 111 executes the control process based on a control program stored in the ROM 112, the auxiliary storage device 12 or the like. The processor 111 starts, for example, the control process illustrated in FIG. 4 according to the actuation of the image forming apparatus 10. Moreover, in the following description, unless otherwise described, the processor 111 proceeds to Act (n+1) after the process of Act (n) (n is a natural number).

In Act 1 of FIG. 4, the processor 111 of the image forming apparatus 10 controls the panel adjustment motor 134 so that the angle of the operation panel 13 is 0°. As illustrated in FIG. 3, the angle of the operation panel 13 is 0° by the control.

In Act 2, the processor 111 waits for the operator M to approach. For example, the processor 111 waits for an output value of the human sensor 133 to be the threshold U1 or more. The processor 111 determines that the operator M approaches when a time change rate of the output value is a certain value or less while in a state where the output value of the human sensor 133 is the threshold U1 or more. When the operator M approaches, the processor 111 determines Yes in Act 2 and proceeds to Act 3.

In Act 3, the processor 111 performs a scanning process to determine the angle of the operation panel 13. That is, the processor 111 controls the panel adjustment motor 134 to change the angle of the operation panel from 0° to 90°. In this case, the processor 111 controls the output value of the illuminance sensor 132 and the output value of the human sensor 133 to be stored in association with the angle of the operation panel when measurement is performed while the angle of the operation panel is changed from 0° to 90°.

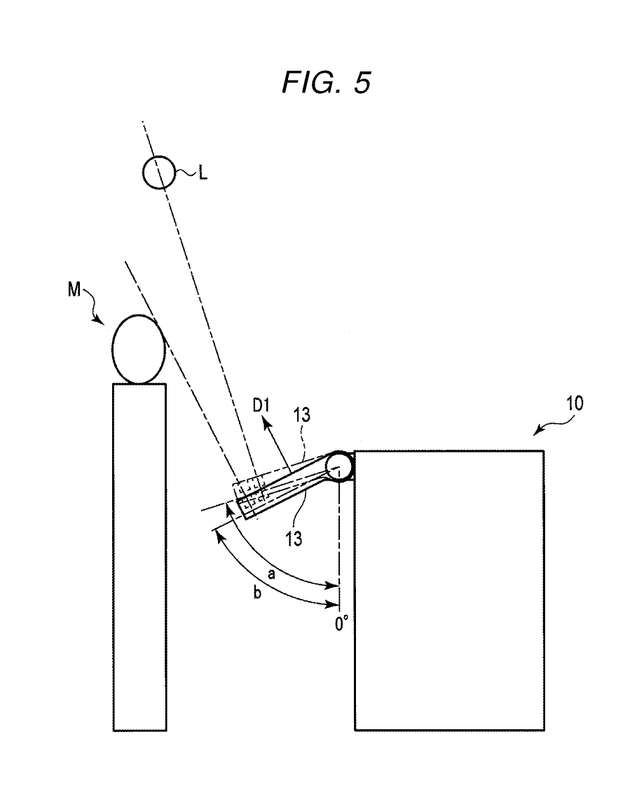

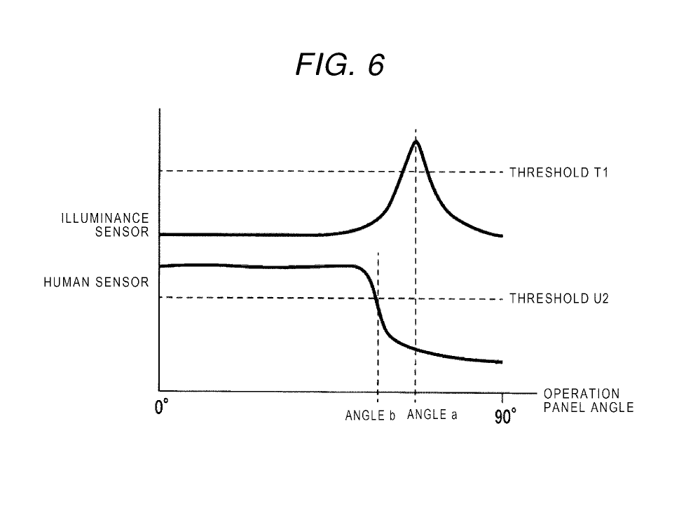

As illustrated in FIG. 5, if a light source L and the eyes of the operator M are in different directions as viewed from the operation panel 13, the output value of the illuminance sensor 132 and the output value of the human sensor 133 are as illustrated in FIG. 6 while the angle of the operation panel is changed from 0° to 90°. FIG. 5 is a side view explaining an operation of the image forming apparatus 10. FIG. 6 is a graph illustrating an example of the output value of the illuminance sensor 132 and the output value of the human sensor 133. In this case, an angle a and an angle b have different values. Moreover, the angle a is an angle of the operation panel 13 when the output value of the illuminance sensor 132 is maximum. The angle b is an angle of the operation panel 13 when a magnitude of an angle change rate of the output value of the human sensor 133 is maximum. In other words, the angle b is an angle of the operation panel 13 when an absolute value of an angle differential of the output value of the human sensor 133 is maximum. Alternatively, the angle b may be an angle of the operation panel 13 when the output value of the human sensor 133 is changed from more than the threshold U2 to the threshold U2 or less. The processor 111 derives the angle a and the angle b based on the output value of the illuminance sensor 132 and the output value of the human sensor 133. Moreover, when the angle b of the operation panel is b°, the sensor direction of the human sensor 133 faces a direction of the head of the operator M viewed from the human sensor 133. The direction is a direction close to a direction of the eyes of the operator M viewed from the human sensor 133. Therefore, when the angle of the operation panel is b°, the sensor direction of the human sensor 133 can be regarded as the direction of the eyes of the operator M viewed from the human sensor 133.

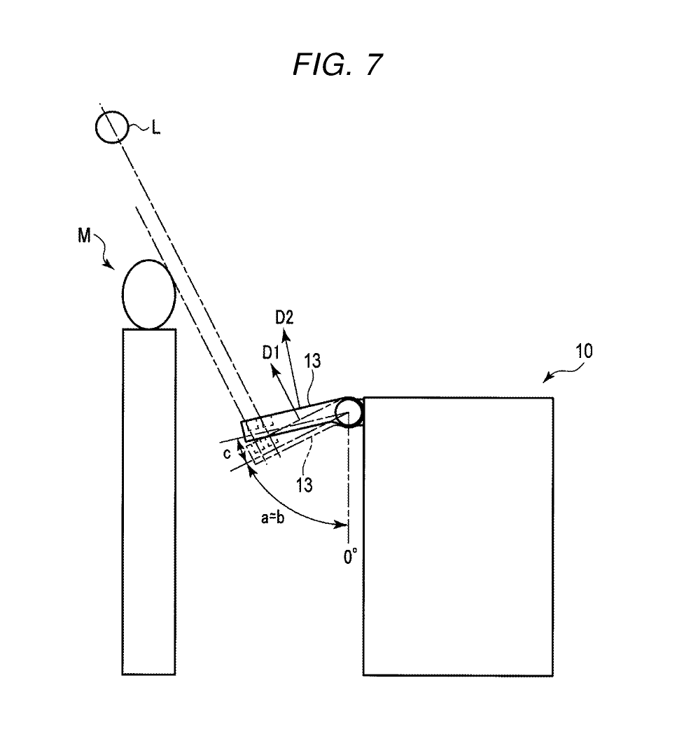

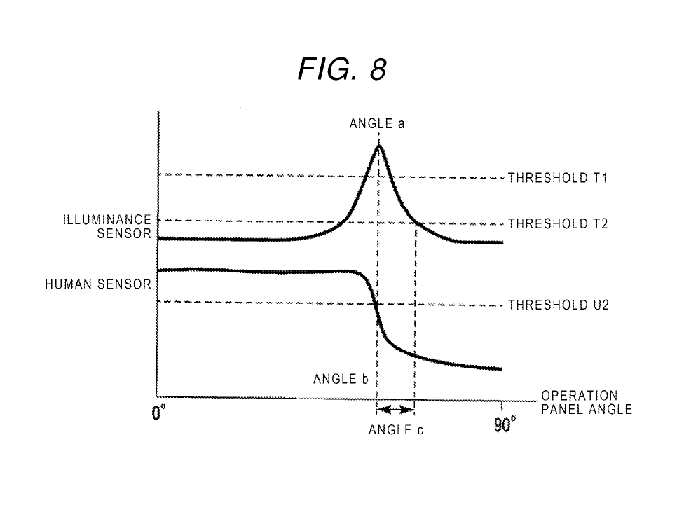

On the other hand, as illustrated in FIG. 7, when the eyes of the operator M and the light source L are in the same direction viewed from the operation panel 13, the output value of the illuminance sensor 132 and the output value of the human sensor 133 are as in FIG. 8 while the angle of the operation panel is changed from 0° to 90°. FIG. 7 is a side view for explaining an operation of the image forming apparatus 10. FIG. 8 is a graph illustrating an example of the output value of the illuminance sensor 132 and the output value of the human sensor 133. In this case, the angle a and the angle b are substantially equal.

In Act 4, the processor 111 determines whether or not the angle a and the angle b are substantially equal. Moreover, the processor 111 determines that the angle a and the angle b are substantially equal when a difference between the angle a and the angle b is the threshold D or less. However, the processor 111 does not determine that the angle a and the angle b are not substantially equal when the output value of the illuminance sensor 132 is less than the threshold T1 at the angle a, even when the difference between the angle a and the angle b is the threshold D or less. The processor 111 determines No in Act 4 and proceeds to Act 5 when the angle a and the angle b have different values or when the output value of the illuminance sensor 132 is less than the threshold T1 at the angle a.

In Act 5, the processor 111 changes the angle of the operation panel 13 so that the display surface of the touch panel 131 faces the direction of the eyes of the operator M. That is, the processor 111 controls the panel adjustment motor 134 so that the angle of the operation panel is b°. Therefore, the display surface of the touch panel 131 faces a direction D1 as illustrated in FIG. 5. The direction D1 is an example of the first direction. Moreover, a direction facing the display surface of the touch panel 131 is the normal direction of the display surface.

On the other hand, the processor 111 determines Yes in Act 4 and proceeds to Act 6 when the angle a and the angle b are substantially equal.

In Act 6, the processor 111 changes the angle of the operation panel 13 so that an illuminance of light which is reflected on the touch panel 131 and strikes on the eyes of the operator M is in a certain value or less. That is, the processor 111 controls the panel adjustment motor 134 so that the angle of the operation panel 13 is (b+c)°. Therefore, the display surface of the touch panel 131 faces a direction D2 as illustrated in FIG. 7. Moreover, an angle c is, for example, an angle obtained by subtracting the angle a from the angle of the operation panel 13 when the output value of the illuminance sensor 132 is the threshold T2 or less. Alternatively, the angle c is an angle obtained by subtracting the angle b from the angle of the operation panel 13 when the output value of the illuminance sensor 132 is the threshold T2 or less. However, it is preferable that the angle c is an angle so that an absolute value is minimum among the angles satisfying the above. The direction D2 is an example of the second direction.

After Act 5 or Act 6, the processor 111 proceeds to Act 7.

In Act 7, the processor 111 waits for a non-operation state. Moreover, the processor 111 determines, for example, the non-operation state when a time, during which various operations such as printing, scanning, copying, or facsimile are not performed and an operation is not performed with respect to the operation panel 13, continues for a certain time. The processor 111 determines Yes in Act 7 in the non-operation state and proceeds to Act 8.

In Act 8, the processor 111 determines whether or not there is the operator M in front of the image forming apparatus 10. For example, the processor 111 determines whether or not there is the operator M in front of the image forming apparatus 10 as follows. That is, the processor 111 controls the panel adjustment motor 134 to reduce the angle of the operation panel 13. In addition, in this case, the processor 111 acquires the output value of the human sensor 133. The processor 111 determines that the operator M is in front of the image forming apparatus 10 when the output value is the threshold U1 or more. On the other hand, it is determined that the operator M is not in front of the image forming apparatus 10 when the output value of the human sensor 133 is the threshold U1 or more even when the angle of the operation panel 13 is lower than a certain value. The processor 111 determines Yes in Act 8 and proceeds to Act 9 when there is the operator M in front of the image forming apparatus 10. The processor 111 detects that the operator is apart from the front of the touch panel 131 by the process of Act 8.

In Act 9, the processor 111 returns the angle of the operation panel 13 to an original angle. That is, the processor 111 controls the panel adjustment motor 134 to cause the angle of the operation panel 13 to be an angle before the process of Act 8 is performed. After Act 9, the processor 111 returns to Act 7.

On the other hand, the processor 111 determines No in Act 8 and returns to Act 1 when there is no operator M in front of the image forming apparatus 10.

The image forming apparatus 10 of the first embodiment measures an illuminance of light incident on the illuminance sensor 132 from the direction (first direction) of the eyes of the operator M, that is, light incident on the illuminance sensor in a direction opposite to the first direction. The image forming apparatus 10 changes the angle of the operation panel 13 so that the display surface of the touch panel 131 faces the first direction when the illuminance of light incident on the illuminance sensor 132 from the first direction is less than the threshold T1. That is, the display surface of the touch panel 131 is at an angle that is perpendicular or substantially perpendicular to the eye direction when the operator M operates the operation panel 13. On the other hand, in the image forming apparatus 10, when the illuminance of light incident on the illuminance sensor 132 from the first direction is the threshold T1 or more because there is a light source of certain brightness or more in the substantially same direction as the eyes of the operator M, the following process is performed. That is, the image forming apparatus 10 changes the angle of the operation panel 13 so that the display surface of the touch panel 131 faces a direction deviated by the angle c from the first direction. As described above, the light reflected on the touch panel 131 does not enter the eyes of the operator M at a certain amount or more. Therefore, the image forming apparatus 10 can prevent light from being reflected on the operation panel 13 and difficult to see. Moreover, it is possible to prevent light from being reflected on the operation panel 13 and difficult to see by using only the illuminance sensor 132 without using the human sensor 133. However, in this case, the display surface of the touch panel 131 may face a direction greatly away from the direction of the eyes of the operator M. When the display surface of the touch panel 131 faces the direction greatly away from the direction of the eyes of the operator M, the display surface of the touch panel 131 becomes difficult to see for the operator M. On the other hand, the image forming apparatus 10 changes the direction of the display surface of the touch panel 131 in the direction different by the angle c from the direction of the eyes of the operator M so that the display surface of the touch panel 131 is unlikely to face a direction greatly away from the direction of the eyes of the operator M. Therefore, the image forming apparatus 10 can prevent the display surface of the touch panel 131 from being difficult to see for the operator M.

### Second Embodiment

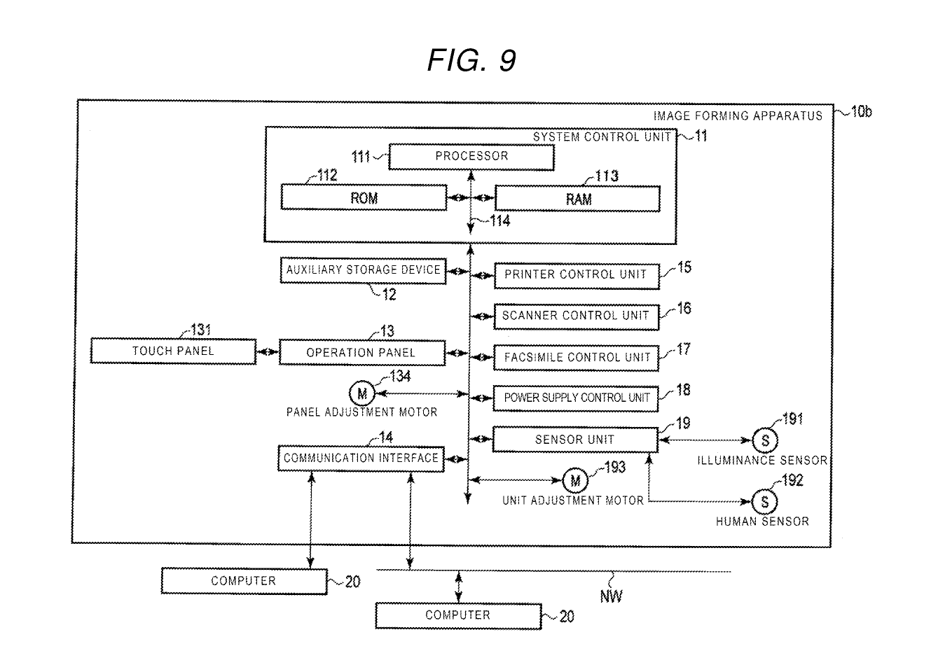

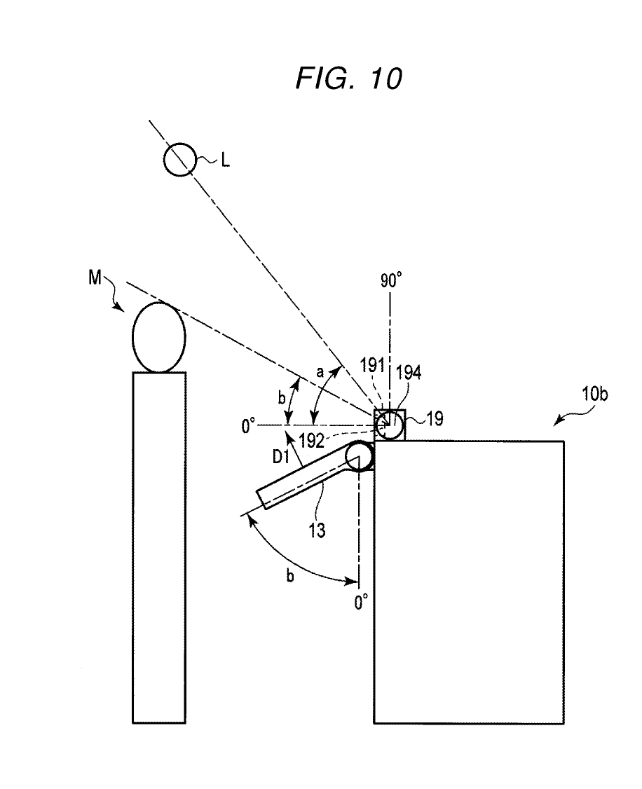

An image forming apparatus 10b according to a second embodiment will be described with reference to FIGS. 9 and 10. FIG. 9 is a block diagram illustrating an example of a main circuit configuration of the image forming apparatus 10b. FIG. 10 is a side view for explaining an outline and an operation of the image forming apparatus 10b. Unlike the first embodiment, an operation panel 13 does not include the illuminance sensor 132 and the human sensor 133. However, unlike the first embodiment, the image forming apparatus 10b includes a sensor unit 19. The image forming apparatus 10b is an example of the display device.

The sensor unit 19 includes an illuminance sensor 191, a human sensor 192, a unit adjustment motor 193, and a rotation unit 194.

Similar to the illuminance sensor 132 of the first embodiment, the illuminance sensor 191 measures and outputs an illuminance or the like.

Similar to the human sensor 133 of the first embodiment, the human sensor 192 measures and outputs a physical quantity.

The unit adjustment motor 193 is a motor which changes directions of the illuminance sensor 191 and the human sensor 192 to the elevation and depression angle direction by rotating the sensor unit 19 around the rotation unit 194. The unit adjustment motor 193 is an example of a second motor.

As illustrated in FIG. 10, the sensor unit 19 is capable of rotating, for example, in a range including 0° to 90°. Moreover, when the sensor directions of the illuminance sensor 191 and the human sensor 192 are parallel to the ground and the sensor direction faces a side on which the operator M stands, the angle of the sensor unit 19 is 0°. When the sensor directions of the illuminance sensor 191 and the human sensor 192 are perpendicular to the ground and the sensor directions face upward, the angle of the sensor unit 19 is 90°.

Moreover, since the other configurations of the image forming apparatus 10b are the same as those of the image forming apparatus 10 of the first embodiment, the description thereof will be omitted.

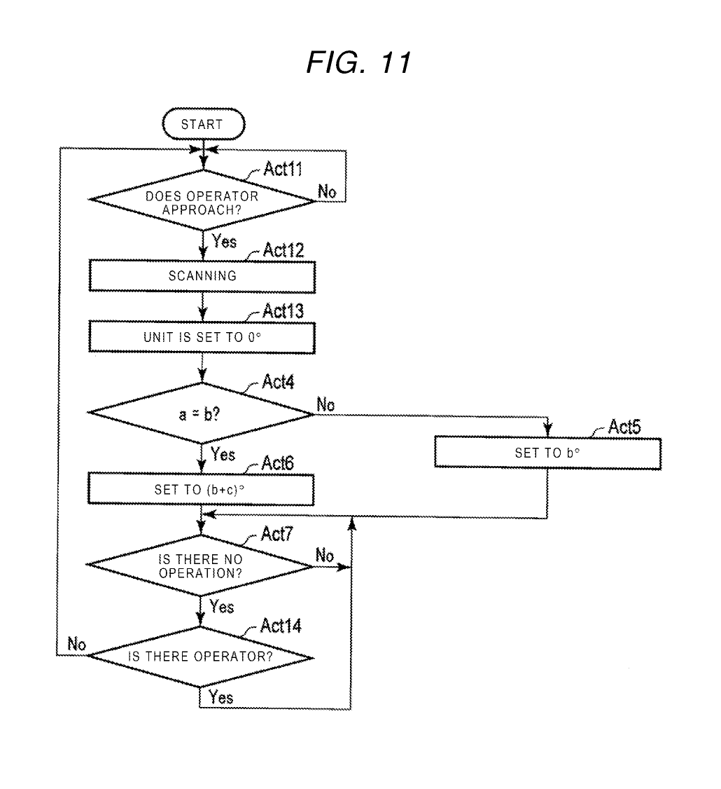

Hereinafter, an operation of the image forming apparatus 10b according to the second embodiment will be described with reference to FIG. 11. Moreover, a content of a process in the following operation explanation is an example and various processes capable of obtaining similar results can be appropriately used. FIG. 11 is a flowchart of a control process by a processor 111 of the image forming apparatus 10. The processor 111 executes the control process based on a control program stored in the ROM 112, the auxiliary storage device 12, or the like.

In Act 11 of FIG. 11, the processor 111 waits for the operator M to approach. For example, the processor 111 waits for an output value of the human sensor 192 to be a threshold U1 or more. The processor 111 determines that the operator M approaches when a time change rate of the output value is a certain value or less while in a state where the output value of the human sensor 192 is the threshold U1 or more. When the operator M approaches, the processor 111 determines Yes in Act 11 and proceeds to Act 12.

In Act 12, the processor 111 performs a scanning process to determine the angle of the operation panel 13. That is, the processor 111 controls the unit adjustment motor 193 to change the angle of the sensor unit 19 from 0° to 90°. In addition, in this case, the processor 111 controls the output value of the illuminance sensor 191 and the output value of the human sensor 192 to be stored in association with the angle of the sensor unit 19 when measurement is performed while the angle of the sensor unit 19 is changed from 0° to 90°. The processor 111 derives the angle a and the angle b based on the output value of the illuminance sensor 191 and the output value of the human sensor 192.

In Act 13, the processor 111 controls the unit adjustment motor 193 to cause the angle of the sensor unit 19 to be 0°. After Act 13, the processor 111 proceeds to Act 4.

In the second embodiment, when Yes is determined in Act 7, the processor 111 proceeds to Act 14.

In Act 14, the processor 111 determines whether or not there is the operator M in front of the image forming apparatus 10b. For example, the processor 111 determines whether or not there is the operator M in front of the image forming apparatus 10b as follows. That is, the processor 111 acquires the output value of the human sensor 192. When the output value is the threshold U1 or more, the processor 111 determines that there is the operator M in front of the image forming apparatus 10b. When there is the operator M in front of the image forming apparatus 10b, the processor 111 determines Yes in Act 14 and returns to Act 7.

On the other hand, when the output value is less than the threshold U1, the processor 111 determines that there is no operator M in front of the image forming apparatus 10b. When there is no operator M in front of the image forming apparatus 10b, the processor 111 determines No in Act 14 and returns to Act 11.

According to the image forming apparatus 10b of the second embodiment, when there is no operator M, the angle of the operation panel 13 may not return to 0°. As a result, the image forming apparatus 10b can reduce an amount of rotation of the operation panel as compared to the first embodiment. As the amount of the rotation of the operation panel, the operator M may feel troublesome. Therefore, the image forming apparatus 10b of the second embodiment can prevent the operator M from feeling troublesome.

### Third Embodiment

Hereinafter, an image forming apparatus 10b of a third embodiment will be described. Since a configuration of the image forming apparatus 10b of the third embodiment has the same configuration as that of the image forming apparatus 10b of the second embodiment, the description thereof will be omitted.

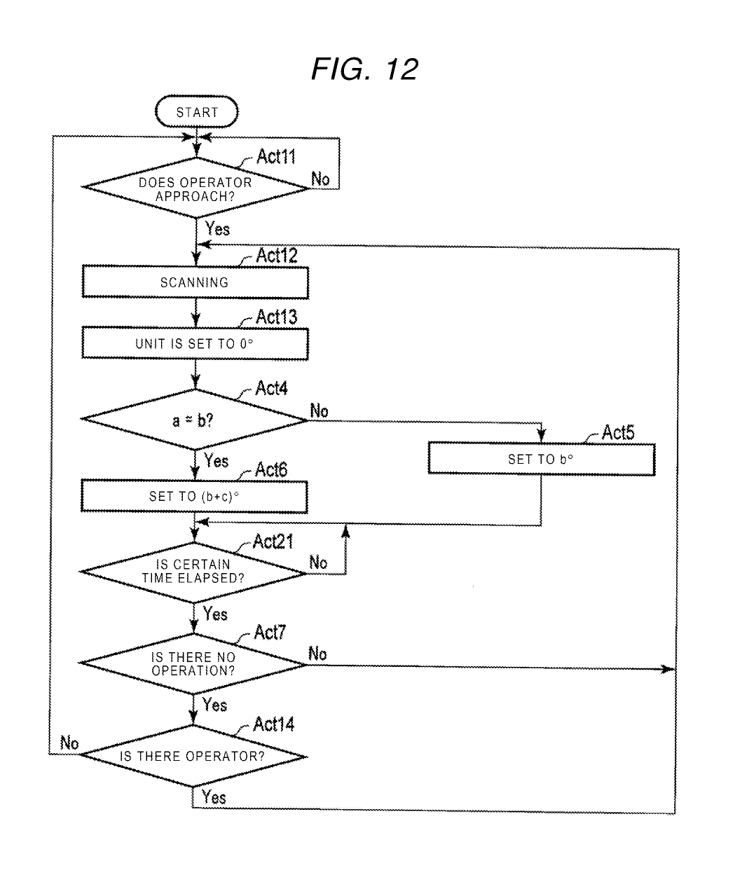

Hereinafter, an operation of the image forming apparatus 10b according to the third embodiment will be described with reference to FIG. 12. Moreover, a content of a process in the following operation explanation is an example and various processes capable of obtaining similar results can be appropriately used. FIG. 12 is a flowchart of a control process by a processor 111 of the image forming apparatus 10b. The processor 111 executes the control process based on a control program stored in a ROM 112, an auxiliary storage device 12, or the like.

After Act 5 or Act 6 of FIG. 12, the processor 111 proceeds to Act 21.

In Act 21, the processor 111 waits for a certain period of time to be elapsed. When a fixed time period is elapsed, the processor 111 determines Yes in Act 21 and proceeds to Act 7.

In the third embodiment, when No is determined in Act 7, the processor 111 returns to Act 12. In addition, when Yes is determined in Act 14, the processor 111 returns to Act 12. Thus, the processor 111 repeats the process of Act 4 to Act 7, Act 12 to Act 14, and Act 21 every fixed time period until there is no operator M in front of the image forming apparatus 10b.

The image forming apparatus 10b of the third embodiment performs the scanning process when every fixed time period is elapsed and changes the angle of the operation panel 13 based thereon. Therefore, when the operator M moves, the angle of the operation panel 13 is changed each time. Therefore, in the image forming apparatus 10b of the third embodiment, it is possible to prevent the display surface of the touch panel 131 from being difficult to see due to the movement of the operator M.

### Fourth Embodiment

Hereinafter, an image forming apparatus 10 of a fourth embodiment will be described. Since a configuration of the image forming apparatus 10 of the fourth embodiment has the same configuration as that of the image forming apparatus 10 of the first embodiment, the description thereof will be omitted.

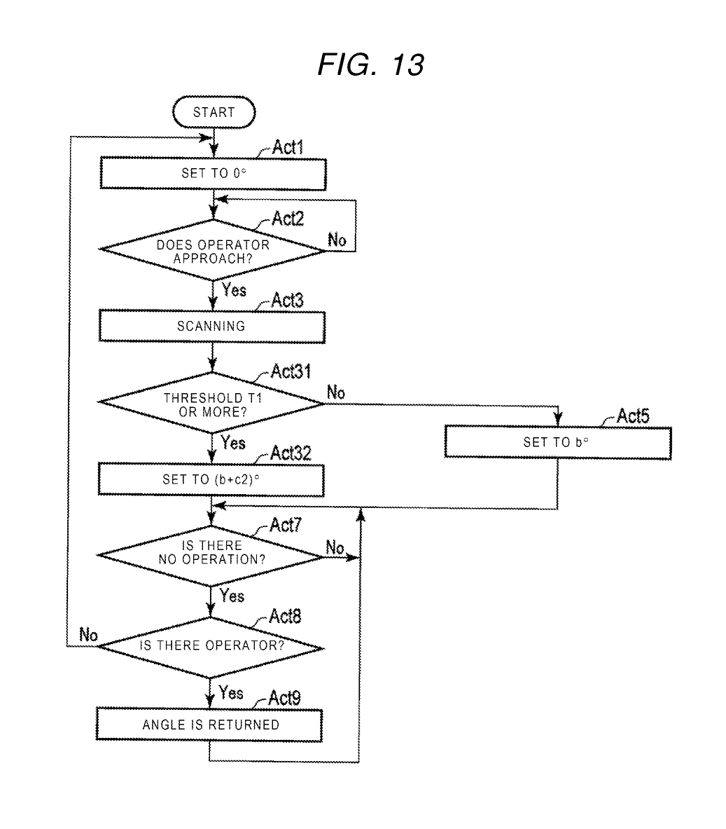

Hereinafter, an operation of the image forming apparatus 10 according to the fourth embodiment will be described with reference to FIG. 13. Moreover, a content of a process in the following operation explanation is an example and various processes capable of obtaining similar results can be appropriately used. FIG. 13 is a flowchart of a control process by a processor 111 of the image forming apparatus 10. The processor 111 executes the control process based on a control program stored in a ROM 112, an auxiliary storage device 12, or the like.

After Act 3 of FIG. 13, the processor 111 proceeds to Act 31.

In Act 31, the processor 111 determines whether or not an output value of an illuminance sensor 132 at the angle b is a threshold T1 or more. When the output value of the illuminance sensor 132 is less than the threshold T1 at the angle b, the processor 111 determines No in Act 31 and proceeds to Act 5. On the other hand, when the output value of the illuminance sensor 132 at the angle b is the threshold T1 or more, the processor 111 determines Yes in Act 31 and proceeds to Act 32.

In Act 32, the processor 111 changes the angle of the operation panel 13 so that an illuminance of light which is reflected on the touch panel 131 and strikes on the eyes of the operator M is a certain value or less. That is, the processor 111 controls the panel adjustment motor 134 so that the angle of the operation panel 13 is (b+c2)°. Moreover, the angle c2 is an angle obtained by subtracting the angle b from the angle of the operation panel 13 when the output value of the illuminance sensor 132 is the threshold T2 or less. However, it is preferable that the angle c2 is an angle so that an absolute value is minimum among the angles satisfying the above. After Act 32, the processor 111 proceeds to Act 7. When the angle of the operation panel 13 is (b+c2)°, a direction facing the display surface of the touch panel 131 is an example of the second direction.

The image forming apparatus 10 of the fourth embodiment does not need to derive the angle a. Therefore, in the image forming apparatus 10 of the fourth embodiment, even when there are many light sources, the angle of the operation panel 13 can be set to an optimum angle that can prevent the display surface of the touch panel 131 from being difficult for the operator M to see. Moreover, in the image forming apparatus 10b, the angle of the operation panel 13 may be determined in the same manner as in the fourth embodiment.

The above-described embodiments may be modified as follows.

In the above-described embodiments, the angle b is formed by regarding the direction of the head of the operator M as the direction of the eyes of the operator M. However, the processor 111 may derive an angle b2 indicating the direction of the eyes of the operator M based on the magnitude of the output value of the human sensor at the angle b. The processor 111 performs a process using the angle b2 instead of the angle b in Act 4 to Act 6. When the angle of the operation panel 13 is b2°, the direction facing the display surface of the touch panel 131 is an example of the first direction.

The illuminance sensor and the human sensor may form a sensor group formed of a plurality of sensors such as a line sensor or a surface sensor. A plurality of angles or an angle of a certain range may also be measured by using such a sensor without rotating the operation panel 13 or the sensor unit 19. By doing as described above, the image forming apparatus can perform the scanning process without rotating the illuminance sensor and the human sensor. Therefore, the image forming apparatus can perform the scanning process at high speed.

The image forming apparatus may include a camera as the human sensor. In this case, the processor 111 detects that the operator M approaches by image recognition based on an image obtained from the camera. In addition, the processor 111 recognizes the direction of the eyes of the operator M by the image recognition. The processor 111 uses the direction of the eyes as the angle b.

In the above-described embodiments, the operation panel 13 includes the rotation unit 135 at an upper portion of the operation panel 13. However, the position of the rotation unit 135 is not limited to the embodiments. For example, the operation panel 13 may also include the rotation unit 135 at a lower portion of the operation panel 13. Alternatively, the operation panel 13 may also include the rotation unit 135 between the upper portion and the lower portion of the operation panel 13 of a back side of the operation panel 13 or the like.

The processor 111 may correct the angle b based on the magnitude of the output value of the human sensor 133 or the human sensor 192 at the angle b, and the distance between the human sensor 133 or the human sensor 192 and the touch panel 131. That is, the processor 111 may estimate the angle b when it is assumed that there is the human sensor on the display surface of the touch panel 131. By doing as described above, it is possible to derive the angle b further accurately.

In the above-described embodiments, the operation panel 13 and the sensor unit 19 can be rotated in the elevation and depression angle direction. However, the operation panel 13 and the sensor unit 19 may be rotatable also in directions other than the elevation and depression angle direction such as left and right. In this case, the image forming apparatus 10 or the image forming apparatus 10b performs, for example, the scanning process in directions other than the elevation and depression angle direction so as to face the display surface of the touch panel 131 regardless the elevation and depression angle direction in various directions. By doing as described above, the image forming apparatus 10 or the image forming apparatus 10b can cope with the reflection of light from various directions. Therefore, in the image forming apparatus 10 or the image forming apparatus 10b, it is possible to further prevent light from being reflected on the operation panel 13 to be difficult to see as compared to the above-described embodiments. In addition, in the image forming apparatus 10 or the image forming apparatus 10b, even when the operator M stands at a position shifted to the left or right with respect to the operation panel 13, the display surface of the touch panel 131 can face the direction of the eyes of the operator M.

The image forming apparatus 10 or the image forming apparatus 10b may perform the scanning process at a range different from 0° to 90°. For example, when the output value of the illuminance sensor at the angle b is not the threshold T2 or more at the time when the angle b can be derived, the processor 111 completes the scanning process. In the processor 111, even when the angle a cannot be derived, the angle a and the angle b are considered to be different values, and No is determined in the process of Act 4. Besides, the range of the angle at which the scanning process is performed is not limited as long as the object of the embodiment can be achieved.

The image forming apparatus 10 or the image forming apparatus 10b may use the output value of the illuminance sensor stored in Act 3 in the next and subsequent scans. When most of the light sources are indoor light, the output value of the illuminance sensor does not change so much with time. Therefore, even if the stored output value is used again, the image forming apparatus 10 or the image forming apparatus 10b can expect the same effects as those of the first to fourth embodiments.

In the above-described embodiments, the image forming apparatus is described as an example, but the display device of the embodiment is not limited to the image forming apparatus. The above-described embodiments can also be applied to various apparatuses provided with a display, or to a single display. Moreover, the various apparatuses and displays to which the above-described embodiments are applied are examples of a display device.

Each direction in each of the above-described embodiments is allowed to deviate from the range that achieves the object of this embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A display device comprising:
a display configured to display information;
a first motor configured to change a direction of a display surface of the display;
an illuminance sensor; and
a processor configured to
determine a first direction corresponding to a direction from a human sensor or the display surface to the eyes of the operator based on first sensing data output from the human sensor,
control the first motor so that a normal direction of the display surface is the first direction when an illuminance of light incident on the illuminance sensor in a direction opposite to the first direction included in second sensing data output from the illuminance sensor is less than a first threshold, and
control the first motor so that the normal direction is a second direction different from the first direction when the illuminance of light incident on the illuminance sensor in the direction opposite to the first direction is the first threshold or more.

2. The device according to claim 1,
wherein the processor detects the operator based on the first sensing data and determines the first direction according to detection of the operator.

3. The device according to claim 2,
wherein the processor detects that the operator is apart from a front of the display based on the first sensing data and starts detection of the operator according to detection that the operator is apart from the display.

4. The device according to claim 1,
wherein the processor determines the second direction so that the illuminance of light incident on the illuminance sensor in a direction opposite to the second direction is a second threshold or less.

5. The device according to claim 1, further comprising:
a second motor configured to change directions of the human sensor and the illuminance sensor.

6. The device according to claim 1,
wherein the processor determines a direction facing the display surface every fixed time and controls the first motor so that the normal direction of the display surface is the first direction or the second direction based on the determination.

7. The device according to claim 1,
wherein the human sensor and the illuminance sensor form a sensor group.

8. The device according to claim 1,
wherein the processor corrects the first direction based on a distance between the human sensor and the display.

9. An image forming apparatus comprising:
a display configured to display information on image formation;
a first motor configured to change a direction of a display surface of the display;
an illuminance sensor; and
a processor configured to
determine a first direction corresponding to a direction from a human sensor or the display surface to the eyes of the operator based on first sensing data output from the human sensor,
control the first motor so that a normal direction of the display surface is the first direction when an illuminance of light incident from the first direction included in second sensing data output from the illuminance sensor is less than a first threshold, and
control the first motor so that the normal direction is a second direction different from the first direction when the illuminance of light incident from the first direction is the first threshold or more.

10. A display method comprising:
determining a first direction corresponding to a direction from a human sensor or a display surface of a display to the eyes of an operator based on first sensing data output from the human sensor;
controlling a first motor which changes a direction of the display surface so that a normal direction of the display surface is the first direction when an illuminance of light incident from the first direction included in second sensing data output from an illuminance sensor is less than a first threshold; and
controlling the first motor so that the normal direction is a second direction different from the first direction when the illuminance of light incident from the first direction is a first threshold or more.
